(19) United States
(12) Patent Application Publication
(10) Pub. No.: US 2015/0019933 A1
(43) Pub. Date: Jan. 15, 2015

(54) MEMORY CONTROLLER, STORAGE DEVICE, AND MEMORY CONTROL METHOD

(71) Applicant: Kabushiki Kaisha Toshiba, Minato-ku (JP)

(72) Inventors: Susumu YAMAZAKI, Kanagawa (JP); Kenji Yoshida, Kanagawa (JP); Yuuichi Abe, Kanagawa (JP)

(73) Assignee: Kabushiki Kaisha Toshiba, Minato-ku (JP)

(21) Appl. No.: 14/023,875

(22) Filed: Sep. 11, 2013

(30) Foreign Application Priority Data
Jul. 11, 2013 (JP) 2013-145794

(51) Int. Cl. G06F 11/10

(52) U.S. Cl. CPC G06F 11/1068
USPC 714/758

(57) ABSTRACT

A memory controller includes a control unit configured to determine a storage location on a nonvolatile memory every unit data having a constant data length to be written into the nonvolatile memory, a plurality of parity storage units, an access control unit configured to select one parity storage unit on the basis of the storage location, and an XOR operation unit that performs an XOR operation every bit location by using the input unit data and data stored in the selected parity storage unit and stores an operation result of the XOR operation into the selected parity storage unit. Unit data is written into the nonvolatile memory. If the number of unit data which are input has reached a predetermined number, the operation result of the XOR operation stored in the parity storage unit is written into the nonvolatile memory.

### CROSS-REFERENCE TO RELATED APPLICATIONS

This application is based upon and claims the benefit of priority from the prior Japanese Patent Application No. 2013-145794, filed on Jul. 11, 2013; the entire contents of which are incorporated herein by reference.

### FIELD

The present embodiments relate to a memory controller, a storage device, and a memory control method.

### BACKGROUND

A technique of executing error correction coding processing on data stored in a nonvolatile memory, in a memory controller configured to access a nonvolatile memory is known. If the error correction coding processing is executed, data can be recovered when an error has occurred in data stored in the nonvolatile memory.

When using a NAND flash memory (hereinafter referred to as NAND memory) as the nonvolatile memory, writing into the nonvolatile memory is executed by taking a predetermined data length called page as the data unit. When using the NAND memory, intra-page ECC (Error Check and Correct) processing of generating parity on the basis of data to be written onto one page is executed as the error correction coding processing.

In the intra-page ECC processing, an error which has occurred in the intra-page data can be recovered. If data disappearance occurs with a page taken as the unit, however, it is difficult to recover data.

### BRIEF DESCRIPTION OF THE DRAWINGS

FIG. 1 is a diagram illustrating a configuration example of a storage device in a first embodiment;

FIG. 2 is a diagram illustrating a configuration example of a NAND controller;

FIG. 3 is a diagram illustrating an example of data and an ECC parity written into a semiconductor memory;

FIG. 4 is a diagram illustrating an example of a storage format of a semiconductor memory in the first embodiment;

FIG. 5 is a flow chart illustrating an example of an XOR parity generation processing procedure at time of NAND write;

FIG. 6 is a flow chart illustrating an example of an operation procedure at time of NAND read;

FIG. 7 is a flow chart illustrating an example of a processing procedure of error page recovery processing;

FIG. 8 is a diagram illustrating an example of a parity group in a second embodiment; and

FIG. 9 is a diagram illustrating an example of a parity group in a third embodiment.

### DETAILED DESCRIPTION

A memory controller in one embodiment includes a control unit configured to determine a storage location on a nonvolatile memory every unit data having a constant data length to be written into the nonvolatile memory, a plurality of parity storage units, an access control unit configured to select one parity storage unit on the basis of a storage location, and an XOR operation unit that performs an XOR operation every bit location by using the input unit data and data stored in the selected parity storage unit and stores an operation result of the XOR operation into the selected parity storage unit. Unit data is written into the nonvolatile memory. If the number of unit data which are input has reached a predetermined number, the operation result of the XOR operation stored in the parity storage unit is written into the nonvolatile memory.

Exemplary embodiments of a memory controller, a storage device, and a memory control method will be explained below in detail with reference to the accompanying drawings. The present invention is not limited to the following embodiments.

### First Embodiment

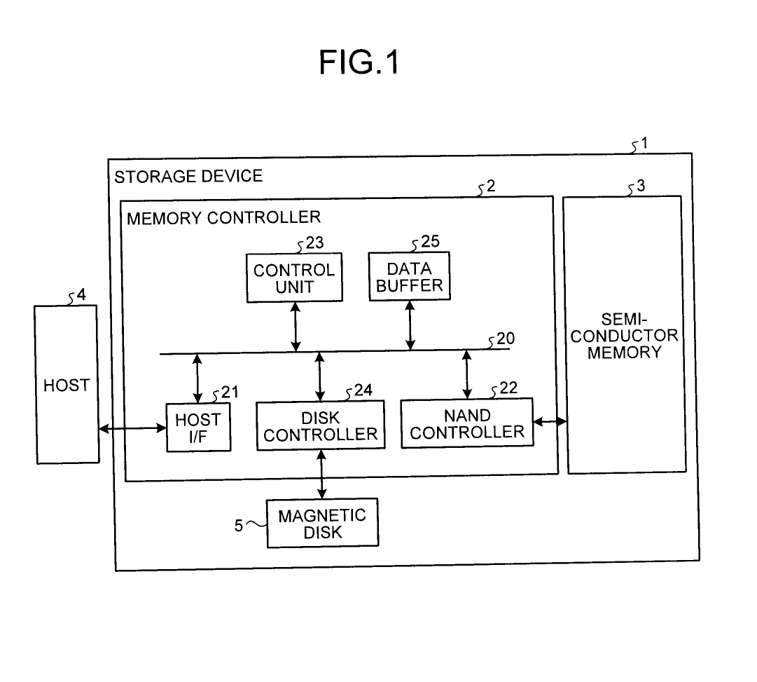

FIG. 1 is a diagram illustrating a configuration example of a storage device 1 in a first embodiment. The storage device 1 in the present embodiment includes a memory controller 2, a semiconductor memory (nonvolatile memory) 3, and a magnetic disk 5. The storage device 1 can be connected to a host 4. In FIG. 1, a state in which the storage device 1 is connected to the host 4 is illustrated. The host 4 may be, for example, an electronic device such as a personal computer or a portable terminal, or an external interface.

The storage device 1 in the present embodiment is a hybrid drive including the semiconductor memory 3 and the magnetic disk 5. In the hybrid drive, the semiconductor memory 3 is used as, for example, a write cache. In other words, data supplied from the host 4 is first written into the semiconductor memory 3 used as a cache memory temporarily. Then, the data is written onto the magnetic disk 5.

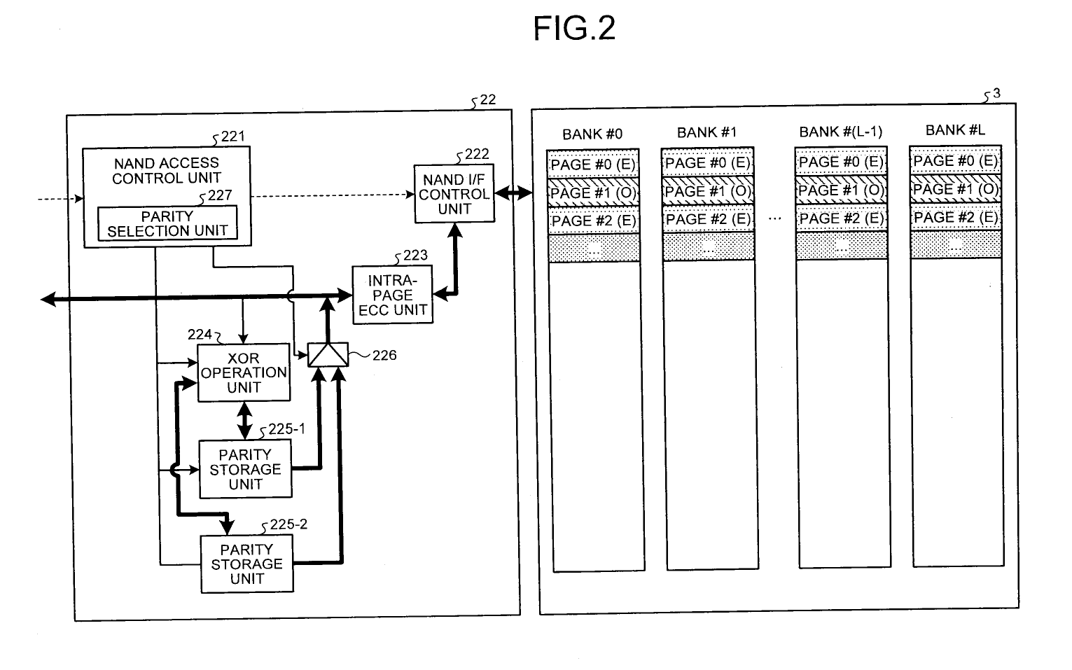

The semiconductor memory 3 is a nonvolatile memory configured to store data in a nonvolatile manner. The semiconductor memory 3 is, for example, a NAND memory. An example in which a NAND memory is used as the semiconductor memory 3 will now be described. Writing into the semiconductor memory 3 is performed by using a write unit (for example, 16 kbytes) called page. Erasing is performed in the semiconductor memory 3 by using a data unit called block. One block includes a plurality of pages. In an example described later with reference to FIG. 2, an example in which the semiconductor memory 3 has L (where L is an integer of at least one) Banks is illustrated. Each Bank has one block or more. It is possible to execute writing into Banks in parallel or reading from Banks in parallel.

The memory controller 2 controls writing into the semiconductor memory 3 and onto the magnetic disk 5 in accordance with a write command (request) from the host 4. The memory controller 2 controls reading from the semiconductor memory 3 and the magnetic disk 5 in accordance with a read command (request) from the host 4. The memory controller 2 includes a host I/F (Interface) 21, a NAND controller 22, a control unit 23, a disk controller 24, and a data buffer 25. The host I/F (Interface) 21, the NAND controller 22, the control unit 23, the disk controller 24, and the data buffer 25 are connected by an internal bus 20. The control unit 23 is connected to the host I/F (Interface) 21, the NAND controller 22, the disk controller 24, and the data buffer 25 by control lines which are not illustrated, respectively.

The control unit 23 is a CPU (Central Processing Unit), an MPU (Micro Processing Unit), or the like. The control unit 23 generally controls the components of the storage device 1. For example, the control unit 23 controls writing onto the magnetic disk 5 and reading from the magnetic disk 5 via the disk controller 24. The control unit 23 controls writing onto the semiconductor memory 3 and reading from the semiconductor memory 3 via the NAND controller 22.

The host I/F 21 executes processing conforming to interface standards between the host I/F 21 and the host 4, and outputs an instruction, data or the like received from the host 4 to the internal bus 20. The host I/F 21 transmits data read out from the semiconductor memory 3 or the magnetic disk 5, a response from the control unit 23, or the like to the host 4.

The NAND controller 22 writes write data into the semiconductor memory 3 on the basis of an order given by the control unit 23. The NAND controller 22 performs reading from the semiconductor memory 3 on the basis of an order given by the control unit 23. The disk controller 24 writes write data onto the magnetic disk 5 on the basis of an order given by the control unit 23. The disk controller 24 performs reading from the magnetic disk 5 on the basis of an order given by the control unit 23.

The data buffer 25 temporarily stores data received from the host 4 by the memory controller 2 until the data is stored into the semiconductor memory 3. The data buffer 25 temporarily stores data read out from the semiconductor memory 3 and the magnetic disk 5 until the data is transmitted to the host 4. The data buffer 25 includes a general-purpose memory such as an SRAM (Static Random Access Memory) or a DRAM (Dynamic Random Access Memory). By the way, write data to be stored into the semiconductor memory 3 may not be stored temporarily into the data buffer 25, but may be input directly to the NAND controller 22. In the same way, the read data read out from the semiconductor memory 3 may not be stored temporarily into the data buffer 25, but may be transmitted directly to the host 4.

A general operation of the storage device 1 will now be described. First, an operation performed when a write command from the host 4 is received, that is, the write operation will be described. If a write command from the host 4 is received, the control unit 23 determines whether to cache write data into the semiconductor memory 3. If the write data is not to be cached, the control unit 23 orders the disk controller 24 to write the write data onto the magnetic disk 5. The disk controller 24 writes the write data onto the magnetic disk 5 on the basis of the order from the control unit 23. Specifically, the disk controller 24 assigns a storage location (physical address) on the magnetic disk 5 to write data stored in the data buffer 25. The control unit 23 retains correspondence of a logical address of the write data to the physical address on the magnetic disk 5 as address information.

On the other hand, if the write data is to be cached into the semiconductor memory 3, the control unit 23 orders the NAND controller 22 to write the write data into the semiconductor memory 3. Specifically, the NAND controller 22 assigns a storage location (physical address) on the semiconductor memory 3 to the write data stored in the data buffer 25 every unit data. The control unit 23 retains correspondence of a logical address of the write data to the physical address on the semiconductor memory 3 as address information. In the present embodiment, data having a length (hereinafter referred to as first unit data) obtained by excluding redundant data such as parity from data which can be stored on one page of the semiconductor memory 3 is defined as unit data. In the present specification, one page in the semiconductor memory 3 means a memory cell group connected to one word line in common. If a single level cell is used as a memory cell, memory cells connected to one word line in common correspond to one page. If a multilevel cell is used as the memory cell, memory cells connected to one word line in common correspond to a plurality of pages. Hereinafter, a physical address on the semiconductor memory 3 assigned to unit data is referred to as page address. The page address is a number indicating a page, and consecutive page addresses are assigned to physically adjacent word lines.

The control unit 23 also assigns a page address on the semiconductor memory 3 to an XOR parity generated on the basis of a plurality of unit data. The XOR parity will be described later. The control unit 23 specifies a page address every unit data, and orders the NAND controller 22 to write (NAND write) the unit data into the semiconductor memory 3.

Upon being ordered to execute NAND write by the control unit 23, the NAND controller 22 executes error correction coding processing on the unit data and generates parity (hereinafter referred to as ECC parity). Furthermore, the NAND controller 22 generates XOR parity on the basis of a plurality of unit data. A method for generating the XOR parity will be described later. The NAND controller 22 writes unit data and corresponding ECC parity onto the same page of the semiconductor memory 3. The NAND controller 22 writes the XOR parity onto a page on the semiconductor memory 3 ordered by the control unit 23. When caching write data into the semiconductor memory 3, the write data may be written onto the magnetic disk 5 as well.

An operation conducted when a read command is received from the host 4, that is, a read operation will now be described. Upon receiving a read command from the host 4, the control unit 23 specifies a storage location of the data on the basis of a logical address of data requested to be read and retained address information. The address information includes information making it possible to determine which of the magnetic disk 5 and the semiconductor memory 3 stores (or whether both of them store) data received from the host 4.

If the specified storage location is the magnetic disk 5, the control unit 23 designates a physical address of data to be read out and orders the disk controller 24 to read the data from the magnetic disk 5. The disk controller 24 reads data from the magnetic disk 5 on the basis of the order from the control unit 23, and transfers the data to the internal bus 20. The host I/F 21 transfers the data read out to the host 4. The data read out may be stored in the data buffer 25 temporarily and then transmitted to the host 4 via the host I/F 21, or may be directly transmitted to the host 4 via the host I/F 21.

If the storage location of the data requested to be read out is the semiconductor memory 3, the control unit 23 designates a physical address of data to be read out and orders the NAND controller 22 to read the data from the semiconductor memory 3. The NAND controller 22 reads data and ECC parity from the semiconductor memory 3 on the basis of the order from the control unit 23, and performs error correction processing by using the ECC parity. If correction in the error correction processing cannot be performed, the NAND controller 22 further reads an XOR parity from the semiconductor memory 3, performs correction by using the XOR parity, and transfers data subjected to the correction to the internal bus 20. If correction in the error correction processing can be performed, the NAND controller 22 transfers data subjected to the correction to the internal bus 20. If it is determined that there is no correction using error correction processing, the NAND controller 22 transfers the data read out from the semiconductor memory 3 to the internal bus 20 as it is. The host I/F 21 transfers the read data (read data subjected to correction in cases where there is an error) transferred to the internal bus 20, to the host 4. The read data may be stored in the data buffer 25 temporarily and then transmitted to the host 4 via the host I/F 21, or may be directly transmitted to the host 4 via the host I/F 21.

On the other hand, when writing data cached in the semiconductor memory 3 onto the magnetic disk 5, a read operation from the semiconductor memory 3 is executed in the same way as the above-described read operation from the semiconductor memory 3. The control unit 23 assigns a physical address on the magnetic disk 5 to data read out from the semiconductor memory 3, and retains a result of the assignment as address information. And the control unit 23 orders the disk controller 24 to write the data read out from the semiconductor memory 3 onto the magnetic disk 5.

An operation for writing into the semiconductor memory 3 and reading from the semiconductor memory 3 in the present embodiment will now be described in detail. FIG. 2 is a diagram illustrating a configuration example of the NAND controller 22. The NAND controller 22 includes a NAND access control unit 221 (access control unit), a NAND I/F control unit (memory interface) 222, an intra-page ECC unit 223 (coding unit and decoding unit), an XOR operation unit 224, parity storage units 225-1 and 225-2, and a selector 226. The NAND access control unit 221 includes a parity selection unit 227.

The NAND access control unit 221 controls access (writing, reading) to the semiconductor memory 3 in accordance with an order from the control unit 23 which is input via a control line (a dashed line in FIG. 2). The NAND I/F control unit 222 executes access to the semiconductor memory 3 on the basis of an order from the NAND access control unit 221. The intra-page ECC unit 223 executes error correction coding processing on write data which is input from the internal bus 20 every predetermined data unit, and generates ECC parity. Furthermore, the intra-page ECC unit 223 executes error correction processing by using read data read out from the semiconductor memory 3 and the ECC parity. The XOR operation unit 224 generates XOR parity by using write data. Furthermore, the XOR operation unit 224 recovers data that is not possible in error correction performed by the intra-page ECC unit 223, by using the XOR parity read out from the semiconductor memory 3. The parity storage units 225-1 and 225-2 are storage units configured to store intermediate operation results of the operation in the XOR operation unit 224. The parity storage units 225-1 and 225-2 include, for example, SRAMs.

Write operation into the semiconductor memory 3 in the present embodiment will now be described. Upon being ordered to execute NAND write, write data is input from the internal bus 20 to the NAND controller 22. The intra-page ECC unit 223 executes error correction coding processing on the write data every data unit (hereinafter referred to as ECC unit) of execution of the error correction coding processing, and generates ECC parity. The intra-page ECC unit 223 outputs write data and ECC parity of the ECC unit to the NAND I/F control unit 222. The NAND I/F control unit 222 writes the write data and the ECC parity of the ECC unit data to be written onto the same page, into a page address ordered by the NAND access control unit 221.

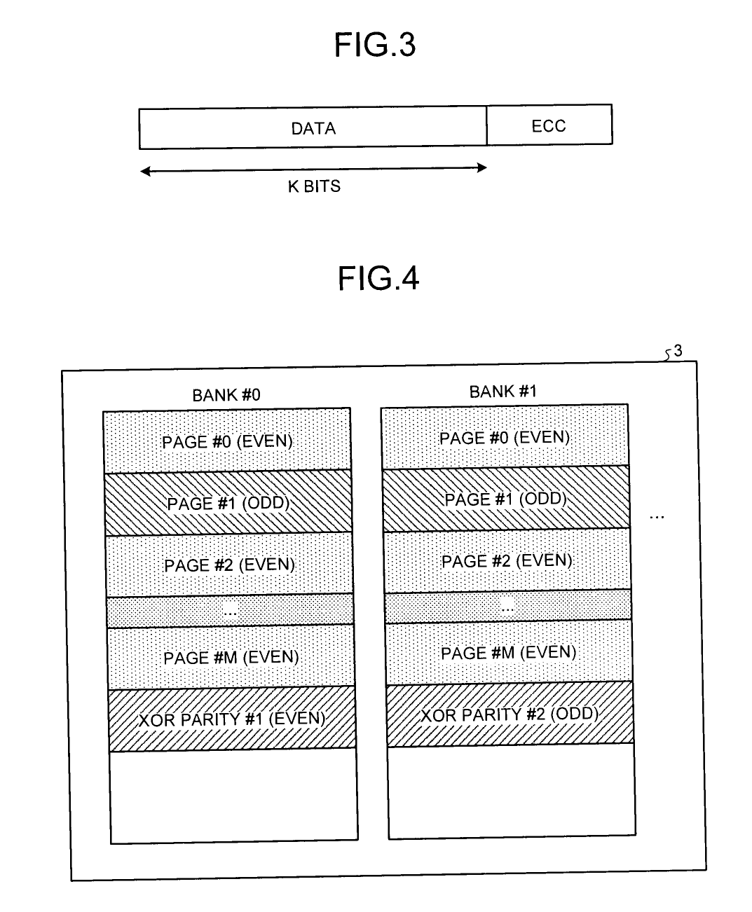

As the error correction coding processing executed by the intra-page ECC unit 223, any coding processing may be used. For example, BCH coding processing, RS (Reed Solomon) coding processing or the like can be used. The ECC unit data is the first unit data which is a data length of unit data, or less. For example, the ECC unit data may be set equal to the first unit data, or may be set equal to one integer-th of the first unit data. When the ECC parity generated by the intra-page ECC unit 223 are written into the semiconductor memory 3, the ECC parity is written onto the same page as data which has become the source of generation of the ECC parity. FIG. 3 is a diagram illustrating an example of data and ECC parity (abbreviated to ECC in FIG. 3) written into the semiconductor memory 3. FIG. 3 illustrates a storage format corresponding to one page in the semiconductor memory 3. In FIG. 3, an example in which ECC parity is generated every first unit data (set equal to K bits) is illustrated. If the ECC unit data is set equal to one J-th of the first unit data (where J is an integer of 2 or more), J ECC parities are stored on the same page.

In cases where writing and reading are executed in parallel every Bank in the semiconductor memory 3 although not illustrated, in general the NAND I/F control unit 222 and the intra-page ECC unit 223 can operate every Bank (every channel). For example, each of the NAND I/F control unit 222 and the intra-page ECC unit 223 has as many circuits as the number of Banks, and those circuits can operate in parallel.

Here, the intra-page ECC unit 223 performs the error correction coding processing and generates the ECC parity. However, the intra-page ECC unit 223 may execute the error correction coding processing or error detection coding processing. The intra-page ECC unit 223 has a function of executing the error correction coding processing or error detection coding processing and generating the parity as a coding unit and a function of performing decoding by using the generated parity and data as a decoding unit. In cases where a parity for error detection is generated by performing the error detection coding processing instead of the error correction coding processing, the intra-page ECC unit 223 generates the parity for error detection by performing error detection coding processing such as CRC (Cyclic Redundancy Check), and writes the parity for error detection into the semiconductor memory 3 in the same way as the above-described ECC parity.

In the present embodiment, the ECC parity (intra-page parity) stored on the same page (the same page in the semiconductor memory 3) as that of the data is generated. In the case of the intra-page parity, however, data cannot be recovered at the time of data disappearance with a page taken as the unit. In the present embodiment, it is made possible to recover data even at the time of data disappearance with a page taken as the unit, by generating the XOR parity using data on different pages. Data stored on adjacent word lines are associated with respective different XOR parities to make it possible to recover data even in cases where data on adjacent word lines in the semiconductor memory 3 have disappeared simultaneously.

FIG. 4 is a diagram illustrating an example of a storage format in the semiconductor memory 3 in the present embodiment. In the present embodiment, the data and the ECC parity as illustrated in FIG. 3 are stored on each of pages in the range of page #0 to page #M (where M is an integer of 1 or more) as illustrated in FIG. 4. In the example illustrated in FIG. 4, supposing cases where memory cells in the semiconductor memory 3 are single level cells, data stored on even-numbered pages and data stored on odd-numbered pages are set to be respective different parity groups in order to associate data stored on adjacent word lines with respective different XOR parities and an XOR parity is generated every parity group. FIG. 4 illustrates an example in which the number of Banks is set equal to two, and two Banks (Bank #0 and Bank #1) are regarded as one set in generating XOR parities. An XOR parity #1 (Even) generated by using data stored on even-numbered pages in the range of page #0 to page #M in the Banks #0 and #1 and an XOR parity #2 (Odd) generated by using data stored on odd-numbered pages in the range of page #0 to page #M in the Banks #0 and #1 are stored on the page #M. In other words, the data stored on even-numbered pages in the range of page #0 to page #M in the Banks #0 and #1 are regarded as parity group #1, and the data stored on odd-numbered pages in the range of page #0 to page #M in the Banks #0 and #1 are regarded as parity group #2. The XOR parity #1 (Even) is generated by using the parity group #1, and the XOR parity #2 (Odd) is generated by using the parity group #2. Here, an example in which the XOR parities are generated by regarding two Banks (Bank #0 and Bank #1) as one set is illustrated. However, the number of Banks forming a set when generating the XOR parities is not restricted to this, but may be any number as long as it is one or more.

The number of Banks (hereinafter referred to as NB) forming a set when generating the XOR parities and the number of pages (M+1 described above) forming a set when generating the XOR parities are determined by the control unit 23. The control unit 23 notifies the NAND access control unit 221 of these determined results. The control unit 23 may determine NB and M in any way. However, the number of bits that can be recovered by using the XOR parity is fixed to one. Therefore, it is desirable to reduce the amount of data which forms a source of generation (that is, make NB and M small) as the error occurrence frequency of data stored in the semiconductor memory 3 becomes higher. For example, therefore, NB and M can be determined depending upon an estimated error occurrence frequency of the data stored in the semiconductor memory 3. For example, a method of setting NB and M equal to arbitrary values as initial values and changing NB and M depending upon the accumulated number of times of erasing in the semiconductor memory 3 or the like is conceivable. NB and M may be changed depending upon the accumulated number of errors detected by the intra-page ECC unit 223. The control unit 23 determines a page address in which the generated XOR parities are to be stored, and orders the NAND access control unit 221 to store the XOR parities into the page address.

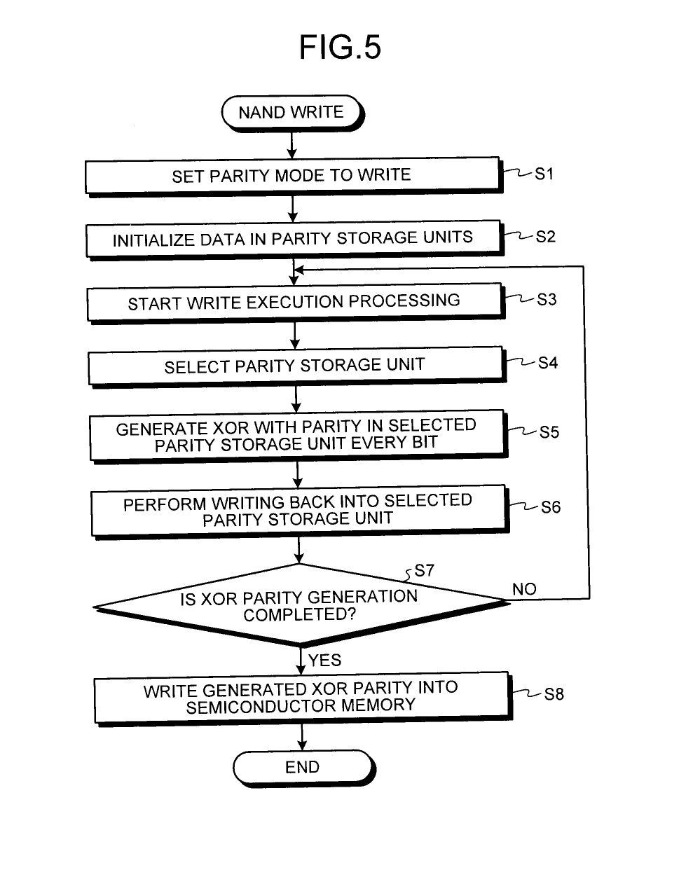

FIG. 5 is a flow chart illustrating an example of an XOR parity generation processing procedure at the time of NAND write. Upon being ordered to perform NAND write by the control unit 23, the NAND access control unit 221 sets a parity mode to “write” (step S1). The NAND access control unit 221 sets the XOR operation unit 224 and the selector 226 to perform an operation at the time of writing described below.

Then, the NAND access control unit 221 initializes data in the parity storage units 225-1 and 225-2 (step S2). The NAND access control unit 221 starts write execution processing (step S3). The write execution processing is processing executed every unit data (that is, every page in the semiconductor memory 3). If the write execution processing is started, the intra-page ECC unit 223 and the NAND I/F control unit 222 executes the above-described operation at the time of writing into the semiconductor memory 3.

On the other hand, write data which is input from the internal bus 20 to the intra-page ECC unit 223 is input to the XOR operation unit 224 as well. The parity selection unit 227 in the NAND access control unit 221 determines whether the page is an odd-numbered page or an even-numbered page every unit data on the basis of the page address given by the control unit 23 as the order, and selects the parity storage unit 225-1 or 225-2 to be used, on the basis of a result of the determination (step S4). This selection result is given to the XOR operation unit 24 as an order. For example, the parity storage unit 225-1 is designated for even-numbered pages whereas the parity storage unit 225-2 is designated for odd-numbered pages. And when writing unit data onto an even-numbered page, the parity selection unit 227 selects the parity storage unit 225-1.

The XOR operation unit 224 performs an XOR operation every bit by using unit data (write data) which is input from the internal bus 20 and data (an intermediate result of the operation of the XOR parity) stored in the selected parity storage unit, and generates an XOR operation result (step S5). The XOR operation unit 224 includes as many XOR circuits as the number (K) of bits in unit data, and performs operations in parallel every bit. In other words, the XOR operation unit 224 calculates XORs of data in the same bit position of respective unit data every bit position in the unit data. The XOR operation result is output from the XOR operation unit 224 as K-bit data. The XOR operation unit 224 writes back the XOR operation result (the K-bit data) into the selected parity storage unit (step S6). In other words, data in the selected parity storage unit is updated to the XOR operation result generated at the step S5.

Then, the NAND access control unit 221 determines whether the XOR parity generation is completed (step S7). If all unit data stored in M pages in the above-described NB Banks are input to the XOR operation unit 224, the NAND access control unit 221 determines that the XOR parity generation is completed.

Unless the XOR parity generation is completed (No at the step S7), the processing returns to the step S3. If the XOR parity generation is completed (Yes at the step S7), the NAND access control unit 221 executes writing of the generated XOR parity into the semiconductor memory 3 (step S8), and finishes the processing. Specifically, the NAND access control unit 221 selects a parity storage unit (either the parity storage unit 225-1 or 225-2) depending upon the page address storing the XOR parity, and notifies the selector 226 of the selection result as an order. The selector 226 outputs data stored in the notified parity storage unit to the intra-page ECC unit 223. The intra-page ECC unit 223 generates an error correction code for the input XOR parity in the same way as the ordinary write data, adds the error correction code to the XOR parity, and outputs a resultant signal to the NAND I/F control unit 222.

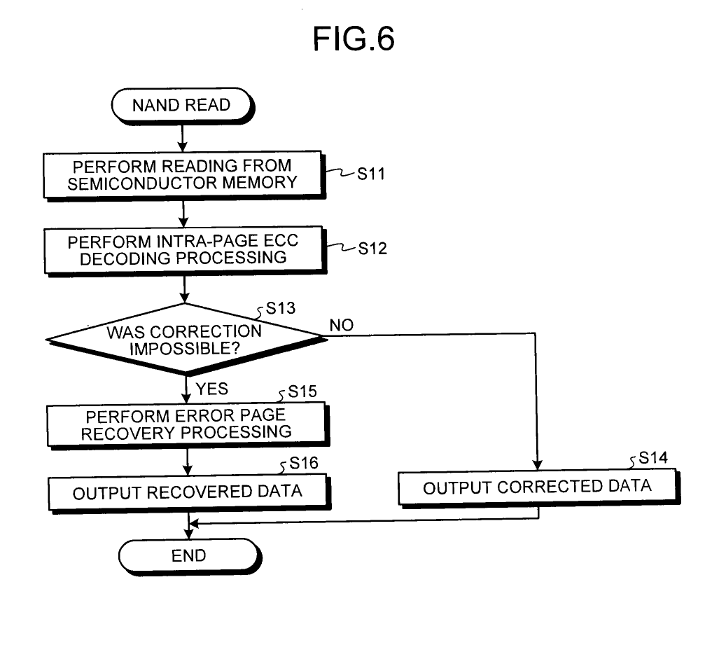

A reading (NAND read) operation from the semiconductor memory 3 in the present embodiment will now be described. FIG. 6 is a flow chart illustrating an example of an operation procedure at the time of NAND read. Upon being ordered to execute NAND read by the control unit 23, the NAND controller 22 starts NAND read execution processing to read a page requested to read (step S11). The control unit 23 specifies a page address to be read, and orders the NAND I/F control unit 222 to read data from the semiconductor memory 3. The NAND I/F control unit 222 inputs data read out from the semiconductor memory 3 to the intra-page ECC unit 223.

The intra-page ECC unit 223 executes error correction processing (intra-page ECC decoding processing) by using the data and the ECC parity stored on the same page in the semiconductor memory 3 (step S12). The intra-page ECC unit 223 determines whether error correction could not be performed by the intra-page ECC decoding processing (step S13). If the error correction could be performed (No at the step S13), then the intra-page ECC unit 223 outputs data subjected to error correction (transfers the data subjected to error correction to the internal bus 20) (step S14). By the way, if there are no errors, the intra-page ECC unit 223 outputs data read out from the semiconductor memory 3 as it is. In FIG. 6, this case is also included in the above-described cases where error correction could be performed.

On the other hand, if error correction could not be performed (Yes at the step S13), the intra-page ECC unit 223 gives a notice of that effect to the NAND access control unit 221, and the NAND access control unit 221 starts error page recovery processing (step S15). The error page recovery processing will be described later. After the error page recovery processing, data after the recovery is output (to the internal bus 20) as read data (step S16).

If the parity for error detection is used instead of the ECC parity, error detection processing is executed by using data and the parity for error detection at step S12 and it is determined whether there are no errors at step S13. If there are no errors, the processing proceeds to step S14. If there is an error, the processing proceeds to step S15.

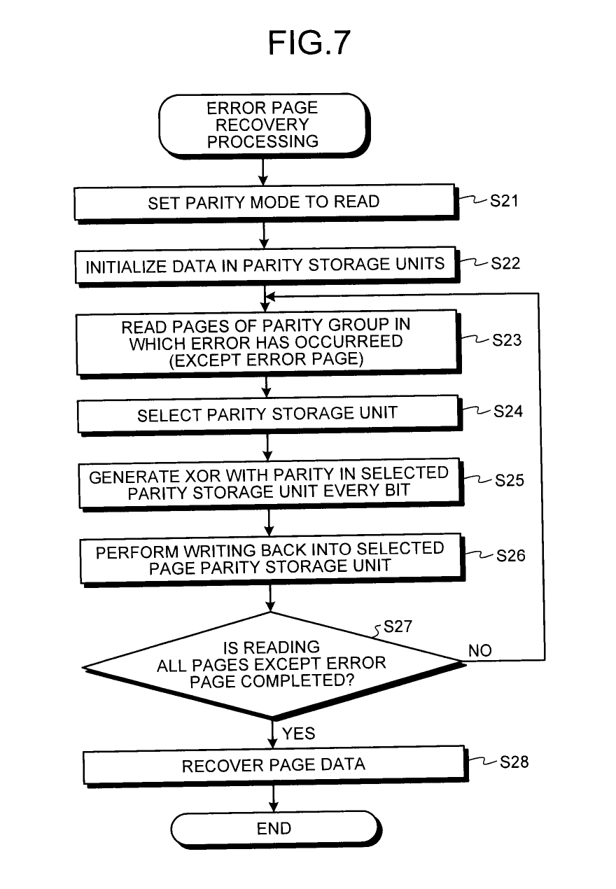

The error page recovery processing will now be described. FIG. 7 is a flow chart illustrating an example of a processing procedure of the error page recovery processing. Upon starting the error page recovery processing, the NAND access control unit 221 sets the parity mode to “read” (step S21). The NAND access control unit 221 sets the XOR operation unit 224 and the selector 226 to perform an operation at the time of read described below.

Then, the NAND access control unit 221 initializes data in the parity storage units 225-1 and 225-2 (step S22). The NAND access control unit 221 orders the NAND I/F control unit 222 to read data corresponding to one page included in data belonging to a parity group including a page on which an error has occurred (on which error correction could not be performed) (except data on the page on which the error has occurred) from the semiconductor memory 3 (step S23). The parity selection unit 227 selects a parity storage unit to be used, on the basis of a page address (page number) of a page read out (step S24). In the case of error page recovery, it suffices to use one parity storage unit and consequently either of the parity storage units may be selected.

The XOR operation unit 224 performs XOR operation every bit by using data read out from the semiconductor memory 3 and data stored in the selected parity storage unit, and generates an XOR operation result (step S25). The XOR operation unit 224 writes back the XOR operation result (K-bit data) into the selected parity storage unit (step S26). In other words, the XOR operation unit 224 updates data in the selected parity storage unit to the XOR operation result generated at the step S25.

The NAND access control unit 221 determines whether reading all pages corresponding to data belonging to the parity group including the page on which the error has occurred is completed (step S27). Unless completed (No at the step S27), the processing returns to the step S23. If reading all pages corresponding to data belonging to the parity group including the page on which the error has occurred (except the page itself on which the uncorrectable error has occurred) is completed (Yes at the step S27), the NAND access control unit 221 outputs the XOR operation result stored in the selected parity storage unit as a recovery result of the page on which the error has occurred (step S28) and finishes the processing.

At the time of writing into the semiconductor memory 3, the XOR parity #1 (Even) and the XOR parity #2 (Odd) represented by Equation (1) below are generated every even-numbered page and odd-numbered page as the XOR parity by the processing described above. An XOR parity #1 (Even) [i] is defined as an i-th bit in the XOR parity #1 (Even) and an XOR parity #2 (Odd) [i] is defined as an i-th bit in the XOR parity #2 (Odd). By the way, it is supposed that the number of Banks forming one set is NB, the number of pages forming one set is M+1, and M is an odd number. Data[a, b, c] represents a c-th bit in unit data stored on page b in Bank #a, and “+” represents an XOR operation.

$$XOR parity \#1 ( Even ) [ i ] = Data [ 0 , 0 , i ] + Data [ 0 , 2 , i ] + … + Data [ 0 , M - 1 , i ] + Data [ 1 , 0 , i ] + Data [ 1 , 2 , i ] + … + Data [ 1 , M - 1 , i ] \\ XOR parity \#2 ( Odd ) [ i ] = Data [ 0 , 1 , i ] + Data [ 0 , 3 , i ] + … + Data [ 0 , M , i ] + Data [ 1 , 3 , i ] + Data [ 1 , 3 , i ] + … + Data [ 1 , M , i ] \qquad ( 1 )$$

On the other hand, at the time of data recovery using the XOR parity, the i-th bit value Cdata[i] in recovered data is calculated by using Equation (2) supposing that a page of recovery object (a page on which an error has occurred) has a page number ke in the Bank #0.

In cases when an even-numbered page is recovered:

$$Cdata [ i ] = XOR parity \#1 ( Even ) [ i ] + Data [ 0 , 0 , i ] + … Data [ 0 , ke - 2 , i ] + Data [ 0 , ke + 2 , i ] + … + Data [ 0 , M - 1 , i ] + Data [ 1 , 0 , i ] + Data [ 1 , 2 , i ] + … + Data [ 1 , M - 1 , i ]$$

In cases when an odd-numbered page is recovered:

$$Cdata [ i ] = XOR parity \#2 ( Odd ) [ i ] + Data [ 0 , 1 , i ] + … Data [ 0 , ke - 2 , i ] + Data [ 0 , ke + 2 , i ] + … + Data [ 0 , M , i ] + Data [ 1 , 1 , i ] + Data [ 1 , 3 , i ] + … + Data [ 1 , M , i ] \qquad ( 2 )$$

In the same way, recovery data can be calculated by an XOR operation of data in the parity group except data on the page of recovery object and the XOR parity in this way.

In the present embodiment, ECC parity to be stored on the same page as data is generated with respect to data to be stored in the semiconductor memory 3, a parity group is generated by using data on a plurality of pages divided into even-numbered pages and odd-numbered pages, and XOR parity is generated every parity group as described above. As a result, data can be recovered with a simple configuration at the time of disappearance of data with a page taken as the unit. In particular, data can be recovered even in cases where data on adjacent word lines have disappeared simultaneously.

### Second Embodiment

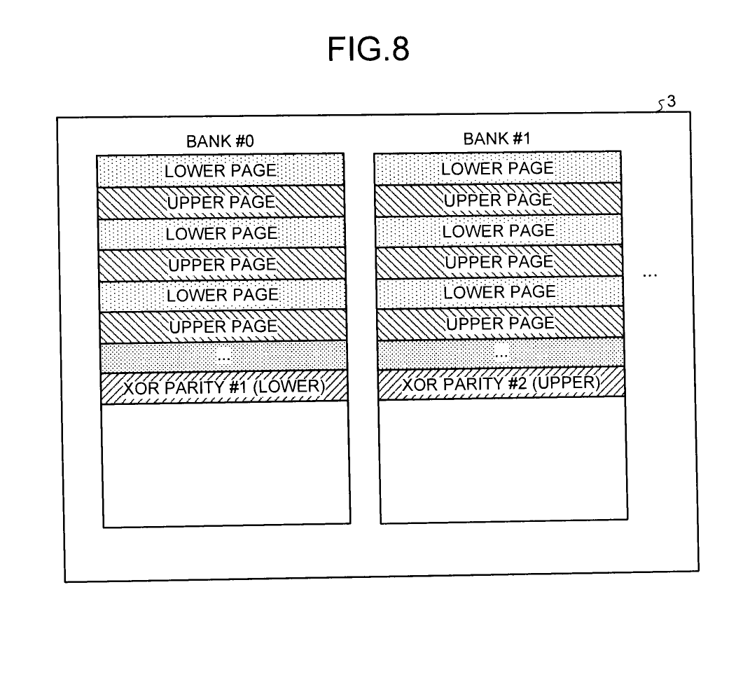

FIG. 8 is a diagram illustrating an example of a parity group in a second embodiment. A configuration of a storage device 1 in the present embodiment is the same as that in the first embodiment. Hereinafter, parts different from the first embodiment will be described while omitting duplicated description for the same parts as those in the first embodiment.

In the present embodiment, an example in which multilevel cells are used as memory cells in the semiconductor memory 3 will be described. In the multilevel cell, for example, in a 2-bit cell, two bits are stored by setting four thresholds in the memory cell. In the multilevel cell, recording of two bits is performed by executing write (program) operation twice. Among them, a page recorded by the first program operation is referred to as Lower page, and a page recorded by the second program operation is referred to as Upper page.

In the present embodiment, one parity group is generated for NB×(M+1) unit data stored in Lower pages, and another parity group is generated for NB×(M+1) unit data stored in Upper pages as illustrated in FIG. 8. In the same way as the first embodiment, NB is the number of Banks forming a set at the time of XOR parity generation. And an XOR parity is generated every parity group. If a failure occurs on one word line in cases where multilevel cells are used, two pages, i.e., a Lower page and an Upper page corresponding to the word line disappear simultaneously. In the present embodiment, different parity groups are generated depending upon whether the page is a Lower page or an Upper page. Even if the Lower page and the Upper page disappear simultaneously, therefore, the page that has disappeared can be recovered.

An XOR parity generation procedure in the present embodiment is obtained by replacing the even-numbered page and the odd-numbered page respectively with the Lower page and the Upper page in the XOR parity generation procedure in the first embodiment illustrated in FIG. 5. For example, the parity storage units 225-1 and 225-2 are assigned to the Lower page and the Upper page, respectively. If a page address assigned to unit data to be written into the semiconductor memory 3 is an address in the Lower page, the parity storage unit 225-1 is selected at the step S4 in FIG. 5.

Parity for the Lower page generated in the present embodiment is denoted by XOR parity #1 (Lower), and parity for the Upper page generated in the present embodiment is denoted by XOR parity #2 (Upper). It is supposed that a page address on the Lower page is Lₖ and a page address on the Upper page is Uₖ. Supposing that XOR parity #1 (Lower) [i] represents the i-th bit in the XOR parity #1 (Lower) and XOR parity #2 (Upper) [i] represents the i-th bit in the XOR parity #2 (Upper), the XOR parity #1 (Lower) [i] and the XOR parity #2 (Upper) [i] are represented by Equation (3).

$$XOR parity \#1 ( Lower ) [ i ] = Data [ 0 , {L}_{0} , i ] + Data [ 0 , {L}_{1} , i ] + … + Data [ 0 , {L}_{M} , i ] + Data [ 1 , {L}_{0} , i ] + Data [ 1 , {L}_{1} , i ] + … + Data [ 1 , {L}_{M} , i ] \\ XOR parity \#2 ( Upper ) [ i ] = Data [ 0 , {U}_{0} , i ] + Data [ 0 , {U}_{1} , i ] + … + Data [ 0 , {U}_{M} , i ] + Data [ 1 , {U}_{0} , i ] + Data [ 1 , {U}_{1} , i ] + … + Data [ 1 , {U}_{M} , i ] \qquad ( 3 )$$

Data recovery processing using XOR parity is also obtained by replacing the even-numbered page and the odd-numbered page in the data recovery processing in the first embodiment illustrated in FIG. 7 with the Lower page and the Upper page, respectively. Data on a page on which an error has been detected can be recovered by performing an XOR operation between data on pages in a parity group to which the page of the recovery object belongs, except the page of the recovery object and XOR parity every bit in the same way as the first embodiment. Operation in the present embodiment except the foregoing description is the same as that in the first embodiment.

In the present embodiment, an example in which multilevel cells of 2 bits/cell are used has been described. Also in cases where multilevel cells of 3 bits/cell are used, data recovery at the time of disappearance with a word line taken as the unit becomes possible in the same way if parity groups are generated for each of three classifications of page (Lower page, middle page, and Upper page). In this case, three parity storage units are provided, and when generating the XOR parity, the parity storage unit is selected depending upon the page classification (Lower page, middle page, and Upper page).

In the present embodiment, ECC parity to be stored on the same page as data is generated for data to be stored in the semiconductor memory 3, a parity group is generated for data on a plurality of pages with Lower pages separated from Upper pages, and XOR parity is generated every parity group, as described above. In cases where multilevel cells are used in the semiconductor memory cell 3, therefore, data can be recovered with a simple configuration when data has disappeared with a word line taken as the unit.

### Third Embodiment

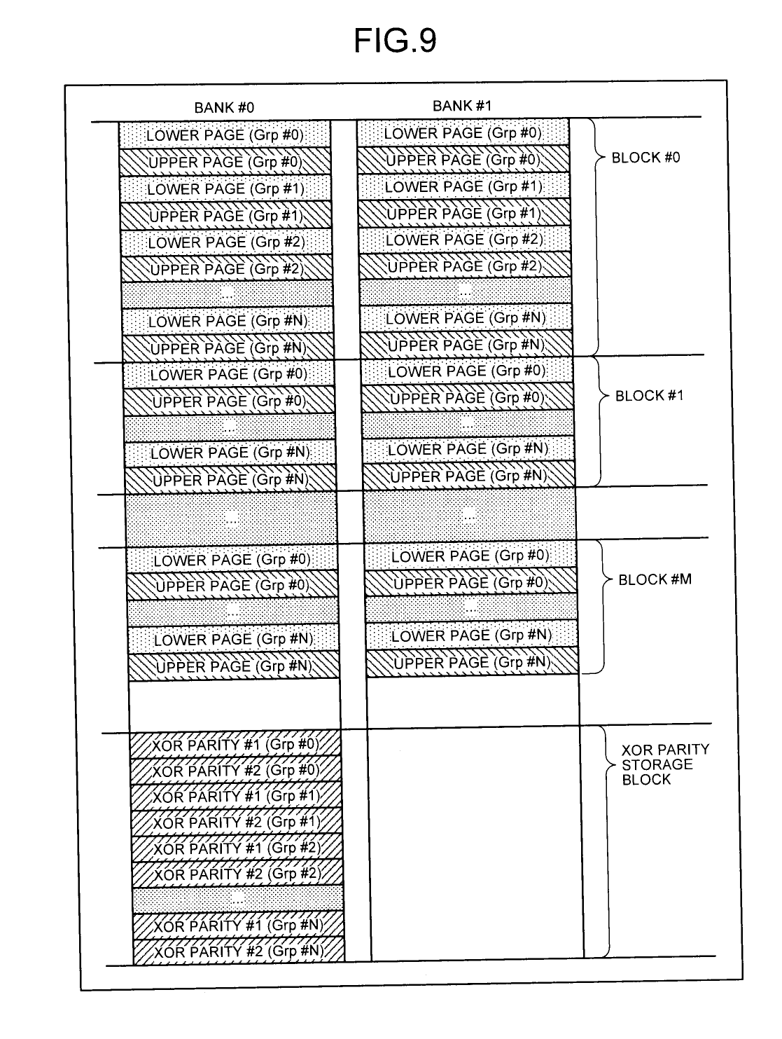

FIG. 9 is a diagram illustrating an example of a parity group in a third embodiment. A configuration of a storage device 1 in the present embodiment is the same as that in the first embodiment. Hereinafter, parts different from the first embodiment will be described while omitting duplicated description for the same parts as those in the first embodiment.

In the present embodiment, the parity group is generated to make it possible to recover data when data of a block unit has disappeared. The block is the unit of erasing in the NAND memory. There is a mode in which the whole block cannot be read, as a defective mode. In the present embodiment, unit data included in one parity group are stored in mutually different blocks in the semiconductor memory 3. After being stored into the semiconductor memory 3, therefore, a parity group includes data on one page in each block as illustrated in FIG. 9.

In the example illustrated in FIG. 9, multilevel cells of 2 bits/cell are supposed and a parity group includes one page in each of 2×(M+1) blocks in total in the range of block #0 to block #M in the Banks #0 and #1. An XOR parity generated by using data in each parity group is stored in an XOR parity storage block. For example, XOR parity #1 (Grp(Group) #0) is generated by using data stored on Lower pages located at heads of the block #0 to block #M in the Banks #0 and #1. XOR parity #2 (Grp(Group) #0) is generated by using data stored on Upper pages located at heads of the block #0 to block #M in the Banks #0 and #1. XOR parity #1 (Grp(Group) #1) is generated by using data stored on second Lower pages of the block #0 to block #M in the Banks #0 and #1.

In an XOR parity generation procedure in the present embodiment, the parity storage unit 225-1 or the parity storage unit 225-2 is selected on the basis of a group number (such as Grp #0) instead of selecting the parity storage unit 225-1 or the parity storage unit 225-2 on the basis of whether the page is an even-numbered page or an odd-numbered page in the XOR parity generation procedure in the first embodiment illustrated in FIG. 5. Determination of data included in a parity group is executed by the control unit 23. The control unit 23 notifies the NAND access control unit 221 of a corresponding group number every unit data. The NAND access control unit 221 selects either the parity storage unit 225-1 or the parity storage unit 225-2 on the basis of the notified group number.

If as many parity storage units as the number (N+1 in FIG. 9) of parity groups to which pages stored in one block belong are provided, any method may be used for an order of writing into the semiconductor memory 3. If N is 2 or more and the number of the parity storage units is less than N+1 (for example, the number of the parity storage units is two), however, a constraint is brought about in the order of writing. In general, one block is written into the semiconductor memory consecutively. In, for example, block #0 in the Bank #0 in the example illustrated in FIG. 9, writing is performed in the order of Lower page (Grp #0), Upper page (Grp #0), Lower page (Grp #1), Upper page (Grp #1), . . . . After writing of the block #0 in the Bank #0 is finished, writing of block #1 in Bank #0 is performed. On the other hand, if two parity storage units are provided, two XOR parities are generated by using two parity groups and data belonging to these parity groups are written into the semiconductor memory 3. If generation of these XOR parities is completed, XOR parity generation for the next two parity groups and writing into the semiconductor memory 3 are executed. In this way, processing is executed every two parity groups. In the example in FIG. 9, writing of Lower page (Grp #0) and Upper page (Grp #0) in each block is performed, then writing of Lower page (Grp #1) and Upper page (Grp #1) in each block is performed. Thereinafter, writing is executed in the order of group. This order of writing is determined by the control unit 23, and the NAND access control unit 221 is notified of the determined order of writing. Substantially, when the control unit 23 gives a notice of a page address of each unit data, information indicating a block of writing destination is also included in the page address. Therefore, the NANS access control unit 221 is notified of the order of writing by the notice of the page address.

At time of data recovery using the XOR parity, data can be recovered by performing an XOR operation between data on pages in a parity group to which the page of recovery object belongs, except the page of recovery object and the XOR parity every bit in the same way as the first embodiment. Operation in the present embodiment is the same as that in the first embodiment except that the parity group forming method and the order of writing into the semiconductor memory 3 are different as described heretofore. An example of the multilevel cell is illustrated in FIG. 9. Also in cases where single level cells are used, however, data can be recovered when data disappears with a block taken as the unit in the same way if a parity group includes one page in each of blocks.

In the present embodiment, ECC parity to be stored on the same page as data is generated for data to be stored in the semiconductor memory 3, a parity group is generated by using data on one page in each of blocks, and XOR parity is generated every parity group, as described heretofore. As a result, data can be recovered when data disappears with a block taken as the unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller that controls a non-volatile memory into which writing is performed in a page which is a unit having predetermined data size, the memory controller comprising:
a control unit that divides data to be written into the nonvolatile memory to generate unit data having a constant data length, and determines a storage location on the nonvolatile memory of the unit data every unit data;
a plurality of parity storage units which are storage units;
an access control unit that selects one out of the plurality of parity storage units on the basis of the storage location every unit data;
an XOR operation unit that performs an XOR operation every bit location by using the input unit data and data stored in the parity storage unit selected by the access control unit and stores an operation result of the XOR operation into the parity storage unit selected by the access control unit; and
a memory interface that writes the unit data into the nonvolatile memory, and writes the operation result of the XOR operation stored in the parity storage unit onto a page in the nonvolatile memory different from a page on which the unit data is stored, when the number of the unit data which are input to the XOR operation unit has reached a predetermined number.

2. The memory controller of claim 1, further comprising a coding unit that executes coding processing on the unit data and generates an intra-page parity,
wherein the memory interface writes the unit data and intra-page parity corresponding to the unit data onto same page in the nonvolatile memory.

3. The memory controller of claim 1, wherein
memory cells in the nonvolatile memory comprise single level cells,
the parity storage units are two in number,
the control unit assigns page numbers consecutively in order of arrangement of word lines in the nonvolatile memory and determines a page number as the storage location, and
the access control unit selects different one of the parity storage units depending upon whether the page number assigned to the unit data is an even number or an odd number.

4. The memory controller of claim 1, wherein
memory cells in the nonvolatile memory comprise multilevel cells,
the parity storage units are provided to become equal to the number of bits which can be stored in each of the memory cells in number,
the control unit assigns a plurality of bits stored in one of the memory cells to different pages respectively every bit in an order in which writing into the semiconductor memory is performed, and causes the storage location to include information that identifies the page, and
the access control unit selects different one of the parity storage units every page assigned to the unit data.

5. The memory controller of claim 1, wherein
in the nonvolatile memory, erasing is performed by taking a block including a plurality of word lines as unit,
the control unit causes the storage location to include a number of a block in which the unit data is stored, and determines a parity group to which the unit data belongs, every unit data, and in the determination of the parity group, the control unit determines the parity group to cause the parity group to include the unit data stored in a plurality of blocks and cause the parity group to include the unit data respectively stored in the plurality of blocks, and
the access control unit selects one of the parity storage units on the basis of a parity group to which the unit data belongs.

6. The memory controller of claim 2, further comprising a decoding unit that executes decoding processing on the basis of the unit data read out from the nonvolatile memory and the intra-page parity, wherein
the access control unit determines whether to execute data recovery using XOR parity on the basis of a result of the decoding processing every unit data, regards the unit data determined to execute data recovery using XOR parity as error page data, and selects one of the parity storage units used for data recovery,
the memory interface reads an XOR parity generated by using the error page data and the unit data obtained by excluding the error page data from the unit data used to generate the XOR parity from the nonvolatile memory as recovery processing data, and
the XOR operation unit recovers the error page data by performing XOR operation every bit, on data stored in the parity storage unit selected for data recovery and the recovery processing data.

7. The memory controller of claim 2, wherein the coding unit executes error correction coding processing as the coding processing.

8. The memory controller of claim 7, wherein the control unit determines the predetermined number on the basis of an accumulated number of times of errors detected by the decoding processing.

9. The memory controller of claim 1, wherein the control unit determines the predetermined number on the basis of an accumulated number of times of writing into the nonvolatile memory.

10. The memory controller of claim 2, wherein the coding unit executes error detection coding processing as the coding processing.

11. A storage device comprising:
a nonvolatile memory into which writing is performed in a page which is a unit having predetermined data size;
a magnetic disk; and
a memory controller that controls read processing and write processing of data with respect to the nonvolatile memory and the magnetic disk,
wherein the memory controller includes:
a control unit that divides data to be written into the nonvolatile memory to generate unit data having a constant data length, and determines a storage location on the nonvolatile memory of the unit data every unit data;
a plurality of parity storage units which are storage units;
an access control unit that selects one out of the plurality of parity storage units on the basis of the storage location every unit data;
an XOR operation unit that performs an XOR operation every bit location by using the input unit data and data stored in the parity storage unit selected by the access control unit and stores an operation result of the XOR operation into the parity storage unit selected by the access control unit; and
a memory interface that writes the unit data into the nonvolatile memory, and writes the operation result of the XOR operation stored in the parity storage unit onto a page in the nonvolatile memory different from a page on which the unit data is stored, when the number of the unit data which are input to the XOR operation unit has reached a predetermined number.

12. The storage device of claim 11, further comprising a coding unit that executes coding processing on the unit data and generates an intra-page parity,
wherein the memory interface writes the unit data and intra-page parity corresponding to the unit data onto same page in the nonvolatile memory.

13. The storage device of claim 11, wherein
memory cells in the nonvolatile memory comprise single level cells,
the parity storage units are two in number,
the control unit assigns page numbers consecutively in order of arrangement of word lines in the nonvolatile memory and determines a page number as the storage location, and
the access control unit selects different one of the parity storage units depending upon whether the page number assigned to the unit data is an even number or an odd number.

14. The storage device of claim 11, wherein
memory cells in the nonvolatile memory comprise multilevel cells,
the parity storage units are provided to become equal to the number of bits which can be stored in each of the memory cells in number,
the control unit assigns a plurality of bits stored in one of the memory cells to different pages of respectively every bit in an order in which writing into the semiconductor memory is performed, and causes the storage location to include information that identifies the page, and
the access control unit selects different one of the parity storage units every page assigned to the unit data.

15. The storage device of claim 11, wherein
in the nonvolatile memory, erasing is performed by taking a block including a plurality of word lines as unit,
the control unit causes the storage location to include a number of a block in which the unit data is stored, and determines a parity group to which the unit data belongs, every unit data, and in the determination of the parity group, the control unit determines the parity group to cause the parity group to include the unit data stored in a plurality of blocks and cause the parity group to include the unit data respectively stored in the plurality of blocks, and
the access control unit selects one of the parity storage units on the basis of a parity group to which the unit data belongs.

16. The storage device of claim 12, further comprising a decoding unit that executes decoding processing on the basis of the unit data read out from the nonvolatile memory and the intra-page parity, wherein
the access control unit determines whether to execute data recovery using XOR parity on the basis of a result of the decoding processing every unit data, regards the unit data determined to execute data recovery using XOR parity as error page data, and selects one of the parity storage units used for data recovery,
the memory interface reads an XOR parity generated by using the error page data and the unit data obtained by excluding the error page data from the unit data used to generate the XOR parity from the nonvolatile memory as recovery processing data, and
the XOR operation unit recovers the error page data by performing XOR operation every bit, on data stored in the parity storage unit selected for data recovery and the recovery processing data.

17. The storage device of claim 12, wherein the coding unit executes error correction coding processing or error detection coding processing as the coding processing.

18. The storage device of claim 11, wherein the control unit determines the predetermined number on the basis of an accumulated number of times of writing into the nonvolatile memory.

19. A memory control method for controlling a nonvolatile memory into which writing is performed in a page which is a unit having predetermined data size, the memory control method comprising:
dividing data to be written into the nonvolatile memory to generate unit data having a constant data length, and determining a storage location on the nonvolatile memory of the unit data every unit data;
selecting one out of a plurality of parity storage units on the basis of the storage location every unit data;
performing an XOR operation every bit location by using the input unit data and data stored in the selected parity storage unit and storing an operation result of the XOR operation into the selected parity storage unit; and
writing the unit data into the nonvolatile memory, and writing the operation result of the XOR operation stored in the parity storage unit onto a page in the nonvolatile memory different from a page on which the unit data is stored, when the number of the unit data which have become input data to the XOR operation has reached a predetermined number.

20. The memory control method of claim 19, further comprising: executing coding processing on the unit data and generating an intra-page parity; and
writing the unit data and the intra-page parity corresponding to the unit data onto same page in the nonvolatile memory.
